(19) United States
(12) Patent Application Publication
(10) Pub. No.: US 2013/0305666 A1
(43) Pub. Date: Nov. 21, 2013

(54) Horse Stirrup

(71) Applicant: Flavio Calzá, Villafranca Padovana (PD) (IT)

(72) Inventor: Flavio Calzá, Villafranca Padovana (PD) (IT)

(73) Assignee: LORENZINI SNC, Villafranca Padovana (PD) (IT)

(21) Appl. No.: 13/981,915

(22) PCT Filed: Feb. 3, 2011
(86) PCT No.: PCT/IB2011/050470

§ 371 Date: Aug. 1, 2013

(30) Foreign Application Priority Data
Jan. 31, 2011 (IT) PD2011A000024

(51) Int. Cl. B68C 3/00

(52) U.S. Cl. CPC B68C 3/00
USPC 54/47

(57) ABSTRACT

The invention relates to an aluminum riding stirrup having a tread with an upper surface where the foot rests and an arched structure that in turn includes one pair of branches whose bases are integral with the two sides of the tread and an upper arch that joins the branches, wherein the stirrup has one or more parts or elements made of titanium.

### FIELD OF THE INVENTION

The present invention concerns stirrups for mounting and riding horses, and in particular it concerns a new stirrup offering high performance and biocompatibility.

### BACKGROUND OF THE INVENTION

Stirrups for mounting and riding horses are known, comprising a portion on which the foot rests, or tread, and a substantially loop-shaped portion, or arched structure, where the rider introduces his/her foot, said arched structure comprising one pair of branches that depart from said tread and are joined at the top forming a loop.

The known stirrups are generally made of a metallic material suited to withstand the pressure exerted by the rider. For these reasons, the stirrups are subjected to load tests.

Lightened stirrups in aluminum are known.

Stirrups must have an ergonomic shape so as to allow the foot to slip easily therein and must also have a given weight so that they substantially remain in the same position and allow the foot to be correctly repositioned if it should accidentally slip out of the stirrup.

The stirrups of known type pose some drawbacks.

Some of the materials with which the known stirrups are made have a resistance to wear that is limited over time.

In particular, the stirrup tread must have a foot supporting surface that guarantees sufficient friction in order to prevent the foot from slipping. The materials currently used, instead, have a limited mechanical resistance to wear and therefore the stirrups must be frequently replaced.

The stirrup is particularly important even for the rider's safety.

In fact, during the performance of the various maneuvers required when riding a horse, the rider's foot may be subjected to traumas or micro traumas due to the fact that it rests on the tread for long and also due to violent impacts against the stirrup and in particular against the branches of the arched structure of the stirrup.

In particular, the external part of the foot rests on and hits against the base of the branch of the arched structure, with consequent traumas and contusions. Furthermore, the stirrups of the known type, which come in contact, even for long periods, with the horse's skin, may cause irritation or injury to the same, made even worse by the use of non biocompatible materials for making the stirrups.

### SUMMARY OF THE INVENTION

In order to overcome all the above mentioned drawbacks, a new type of stirrup for riding has been designed and manufactured, which is made of aluminum and has some parts made of high performance titanium that is highly biocompatible.

The main object of the present invention is to provide a stirrup with high and prolonged mechanical resistance to stress and wear.

Another object of the present invention is to provide a stirrup that guarantees ease of use by the rider thanks to its ergonomic shape that facilitates the introduction of the foot and limits the risk of the foot accidentally slipping out of the stirrup.

Another important object of the present invention is to provide a stirrup that guarantees the rider's safety, thus limiting the risk of foot traumas and contusions.

A further object of the present invention is to ensure high biocompatibility for both the horse and the rider.

These and other direct and complementary objects are achieved by the new riding stirrup whose main components comprise a tread and an arched structure that are integral with each other and form a one-piece aluminum structure, as well as one or more titanium parts.

According to the invention, one or more titanium parts are in any case applied at least to the upper surface of said tread, that is, to the surface where the foot rests.

According to the invention, furthermore, one or more titanium parts can be applied to the external part of the base of one or both of the stirrup branches, that is, the surfaces that may come into direct contact with the animal's skin. In the preferred embodiment of the invention, said tread has its upper surface completely or partly covered with said titanium part, said part being also worked in such a way as to obtain a good friction coefficient and guarantee the grip of the foot, thus preventing the foot from accidentally slipping out of the stirrup.

Said titanium part, for example, is made of a substantially flat sheet provided with a plurality of projections.

Titanium has high mechanical resistance and therefore can offer a friction effect for longer than other materials.

Said bases of one or both of the branches also have, on their external surface, titanium elements or blocks applied thereto in any way, suited to come into contact with the horse's coat and skin, thus substantially serving the function of spacers suited to prevent other parts of the stirrup that are made of different materials from coming into contact with the animal.

The aluminum and titanium parts are subjected to controlled surface oxidation treatments and furthermore, being made with highly biocompatible materials, limit the negative effects on the skin due to the contact, which may even be prolonged, and to impacts, even violent, between the stirrup and the horse.

The stirrup is particularly shaped in such a way as to guarantee high performance and high mechanical resistance to stress.

In particular, the arched structure of the new stirrup is preferably a one-piece element and therefore is highly resistant to tensile stress.

Furthermore, said arched structure has a preferably triangular cross section that makes it highly resistant to torsional stress.

The tread of the new stirrup is shaped in such a way as to facilitate the introduction of the foot.

Said tread has its upper surface, where the foot rests, inclined downwards with respect to the side from which the foot slips into the stirrup, substantially configured so as to favor the introduction of the foot.

The weight of the stirrup is such as to maintain a correct position when it is suspended from the stirrup leathers that connect it to the saddle, so that even if the foot accidentally slips out of the stirrup this remains substantially in the same position and the rider can find it easily and quickly.

Said stirrup, furthermore, is shaped in such a way as to limit the traumas that the foot can suffer.

In said new stirrup, in fact, the bases of the branches of the arched structure, that is, the parts where the foot exerts the most pressure, are larger than in the known stirrups, so as to increase the surface on which the foot rests and to limit the presence of supporting surfaces with sharp angles that may cause traumas and contusions to the foot.

The new stirrup can also be subjected to further surface finish treatments like polishing, sand-blasting, silking, varnishing, coloring, and others.

### BRIEF DESCRIPTION OF THE DRAWINGS

The characteristics of the new stirrup will be highlighted in greater detail in the following description, with reference to the drawings attached hereto as non-limiting examples.

FIG. 1 shows a three-dimensional view of a stirrup (1) according to the invention, while FIGS. 2, 3 and 4 respectively show a side view, a front view and a plan view of a stirrup (1) according to the invention.

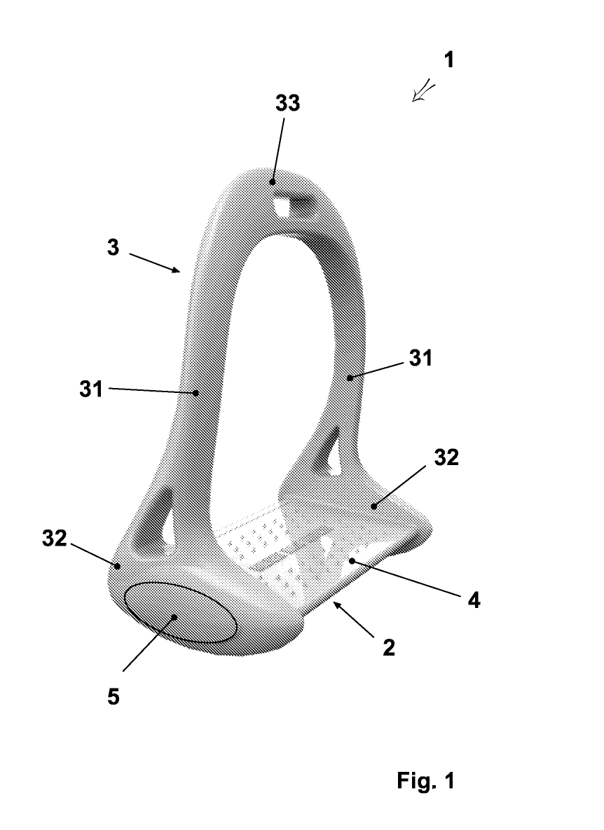

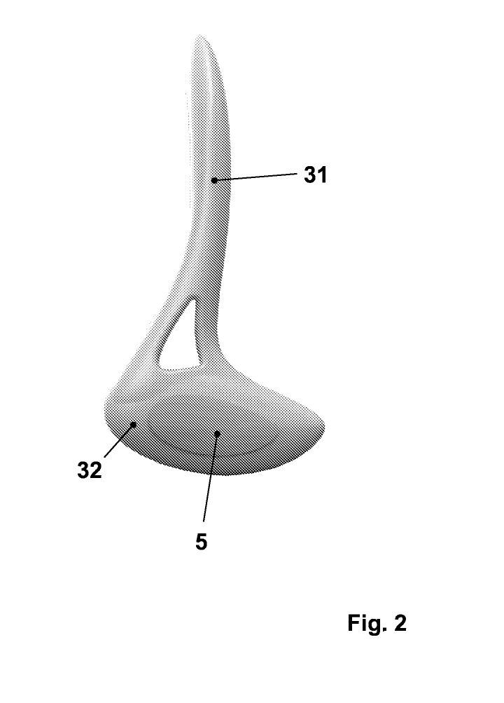

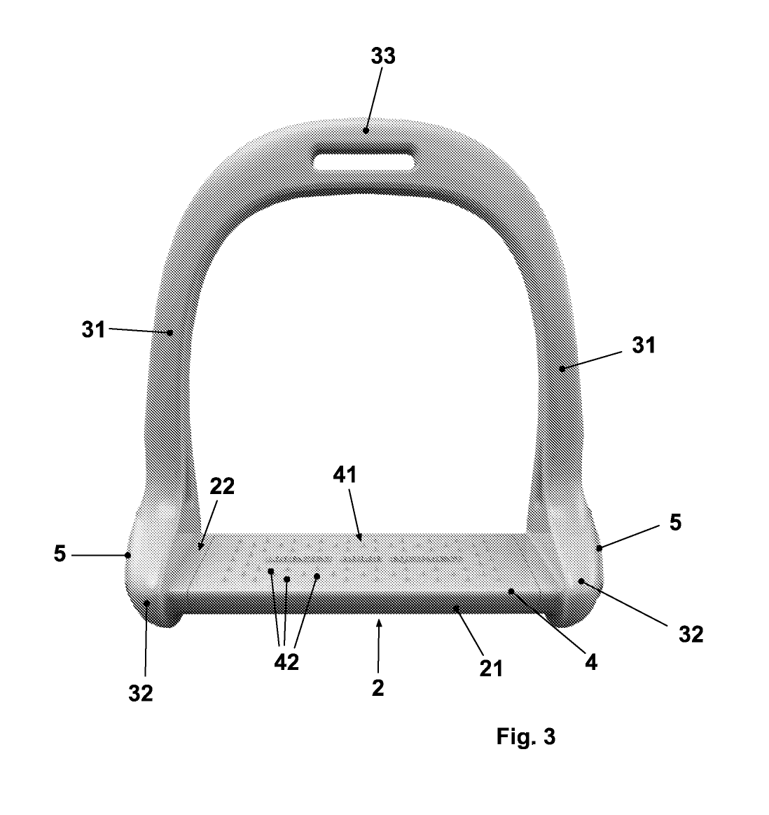

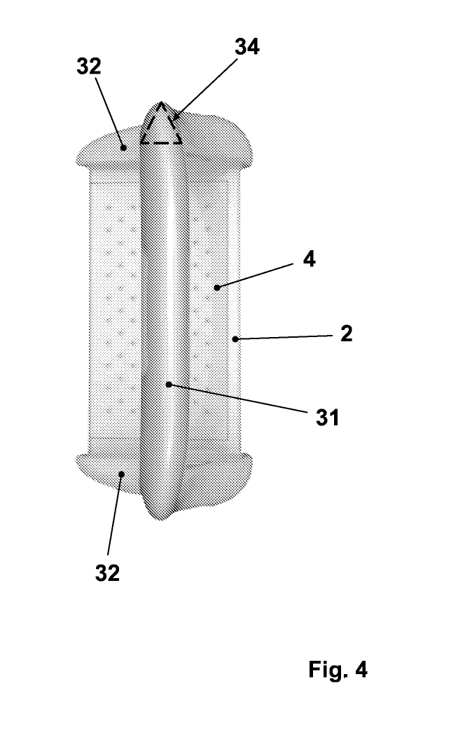

### DETAILED DESCRIPTION OF A PREFERRED EMBODIMENT OF THE INVENTION

The invention relates to a new riding stirrup (1) comprising a tread (2) and an arched structure (3) that are integral with each other so as to form a one-piece element and are preferably made of aluminum.

Said tread (2) comprises a substantially flat body (21) with a substantially flat upper surface (22).

Said upper surface (22) of said tread (2) is however provided with an element or sheet (4) made of titanium, in turn comprising a flat upper surface (41), where the rider's foot rests, worked so as to feature projections (42) or rough portions suited to increase the friction of the surface (41) and therefore the grip of the foot thereon.

In the preferred embodiment of the invention, said titanium element or sheet (4) occupies the entirety of said upper surface (22) of the tread (2), in such a way as to maximize the surface (41) where the foot rests.

The tread of the new stirrup is shaped in such a way as to facilitate the introduction of the foot.

Said tread (2) is preferably inclined downwards with respect to the side from which the foot is introduced in the stirrup (1), as shown in FIG. 3. The arched structure (3) of the new stirrup (1) comprises one pair of branches (31) whose bases (32) are integral with the two sides (23) of the tread (2) and an upper arched element (33) that joins the two branches (31). Said arched structure (3) is preferably a one-piece element and has a substantially triangular cross section (34), indicated with a dashed line in FIG. 4.

Said bases (32) of the branches (31) of the arched structure (3) are widened, having dimensions that are at least equal to or even exceed the width of the tread (2), as shown in FIG. 4.

Said bases (32) of one or preferably both of the branches (31) of the arched structure (3) also have, on their preferably convex or rounded external surface (36), titanium elements or blocks (5) that are in any way applied thereto, suited to come into contact with the horse's coat and skin, thus substantially serving the function of spacers.

Therefore, with reference to the above description and the attached drawings, the following claims are expressed.

The invention claimed is:

1. An aluminum riding stirrup comprising:
a tread with an upper surface where a foot of a rider rests; and
an arched structure that in turn comprises one pair of branches having bases integral with two sides of the tread and an upper arched structure that joins said branches,
wherein one or more parts or elements are made of titanium.

2. The aluminum riding stirrup according to claim 1, wherein the aluminum riding stirrup comprises at least one of said titanium parts or elements applied in any way to said upper surface of said tread, and wherein said titanium part or element comprises a contact surface where the foot rests, provided with projections or rough portions suited to increase friction and grip of the foot on said surface.

3. The aluminum riding stirrup according to claim 2, wherein said at least one of said titanium parts or elements occupies an entirety of the upper surface of the tread.

4. The aluminum riding stirrup according to claim 2, further comprising one or more blocks or elements made of titanium, applied in any way to an external surface of said bases of at least one of the branches of the arched structure, said blocks or elements being suited to come into contact with a horse's coat and skin, serving a function of spacers.

5. The aluminum riding stirrup according to the claim 2, wherein the upper surface or contact surface where the foot rests on the tread is inclined downwards with respect to a side from which the foot is introduced in the aluminum riding stirrup, thus facilitating introduction of the foot.

6. The aluminum riding stirrup according to claim 1, wherein said arched structure is a one-piece element of substantially triangular cross section.

7. The aluminum riding stirrup according to claim 1, wherein said tread and said arched structure are integral with each other so as to form a one-piece element.

8. The aluminum riding stirrup according to claim 1, wherein a size of said bases of the branches of the arched structure is equal to or exceeds a width of the tread.

9. The aluminum riding stirrup according to claim 1, wherein components in aluminum and titanium are subjected to one or more of controlled surface oxidation processes or surface finishing treatments.

10. The aluminum riding stirrup of claim 9, wherein said controlled surface oxidation processes or surface finishing treatments include one or more of polishing, sand blasting, silking, varnishing, or coloring.
